(19) United States
(12) Patent Application Publication
(10) Pub. No.: US 2009/0080823 A1
(43) Pub. Date: Mar. 26, 2009

(54) BEARING SYSTEM FOR AN ELECTRIC MOTOR

(76) Inventors: Christa Bauch, Grossbottwar (DE); Eberhard Lung, Ludwigsburg (DE); Ricardo Chombo Vidales, Steinbach (DE); Quoc-Dat Nguyen, Reutlingen (DE); Oliver Eckert, Remseck (DE); Reinhold Lohrmann, Hardthof (DE); Ngoc-Thach Nguyen, Grossbottwar (DE); Richard Gerstenberger, Beilstein (DE)

Correspondence Address: MICHAEL J. STRIKER, 103 EAST NECK ROAD, HUNTINGTON, NY, 11743, US

(21) Appl. No.: 12/095,055

(22) PCT Filed: Oct. 10, 2006
(86) PCT No.: PCT/EP2006/067233

§ 371 Date: Sep. 2, 2008

(30) Foreign Application Priority Data
Dec. 6, 2005 (DE) 102005058078.5

(51) Int. Cl. F16C 33/30

(52) U.S. Cl. 384/518

(57) ABSTRACT

An electric motor (1) having a mount system (2) is used in particular as a motor for power-assisted steering. The mount system (2) has a roller bearing (8) in the form of a movable bearing, wherein a rolling-surface body (25; 26) of the roller bearing (8) has a groove in which a spring element (18) is arranged. When the electric motor (1) is mounted, the spring element (18) is prestressed in a radial direction (20), with the result that play-free mounting of a shaft (5) of the electric motor (1) is ensured in the radial direction (20) by means of the roller bearing (8).

### PRIOR ART

The invention relates to a bearing system for supporting a shaft. In particular, the invention relates to a bearing system for supporting a shaft of an electric motor and to an electric motor having such a bearing system.

From German Patent Disclosure DE 100 19 512 A1, an electric motor is known that is can be designed in particular as a motor for a power window or sliding roof. The known electric motor has a rotor and a stator that serve to drive a shaft. The shaft is in engagement with a gear. One fixed bearing and one loose bearing, the latter located on the end of the shaft, are provided. The loose bearing makes a certain compensation possible for changes in length of the shaft that are due for instance to temperature increases during operation of the electric motor.

In an electric motor of the kind known from DE 100 19 512 A1, a press-fit seat and a sliding seat on the outer race body and on the inner race body can be provided for the loose bearing. The sliding seat has a clearance fit, with the disadvantage that in alternating-stress operation not only loud noise but also increased friction, wear, and a shortening of the service life must all be expected. These disadvantages are especially severe for particular pairs of materials. For instance, the shaft may be embodied of aluminum, while the bearing is of steel. Because of the different thermal expansion, an increase in the play of the clearance fit occurs in certain temperature regions, so that such combinations of material cannot be used under some circumstances because of their attendant disadvantages, in particular noise.

### ADVANTAGES OF THE INVENTION

The bearing system according to the invention having the characteristics of claim 1 and the electric motor of the invention having the characteristics of claim 10 have the advantage over the prior art that in the radial direction, essentially play-free support of the shaft is possible in the roller bearing that forms the loose bearing of the bearing system. Moreover, the embodiment according to the invention makes reliable and in particular reduced-noise operation possible even with pairs of material in which the problem of different thermal expansion coefficients exists.

By the provisions recited in the dependent claims, advantageous refinements of the bearing system recited in claim 1 and of the electric motor recited in claim 10 are possible.

The spring element is advantageously designed as a wormlike tension spring. In the mounted bearing system, reliable prestressing of the spring element can thereby be assured over the life of the electric motor. If the spring element is additionally designed as a closed ring, then the spring element can also be prestressed along its circularly curved center axis. In the mounted state, the spring element is thus kept in its predetermined position. Moreover, because of the radial prestressing of the spring element, an advantageous absorption of the forces of the shaft that act in the radial direction is made possible by the housing or some other component of the electric motor, via the roller bearing. A spring element that is designed as a closed ring may be connected on its ends, by insertion of the first end of the spring element into the second end of the spring element; the first end for instance catches inside the second end, in a manner corresponding to a screw connection. In addition or as an alternative, however, the two ends of the spring element may also be joined by a soldered or welded connection. In the case of a form-locking connection of the two ends of the spring element without an additional soldered or welded connection, the production effort and expense are low, so that the unit costs of the bearing system or electric motor are relatively low in this regard. On the other hand, by means of a soldered or welded connection, high strength is achieved, which can be advantageous for certain applications.

The spring element can be introduced at least partly into a groove provided in the region of the inner race body or of the outer race body. This groove may be provided on the outer race body of the roller bearing, on a housing part of the electric motor that has a recess for receiving the roller bearing, on the inner race body, or in the region of the inner race body on the shaft. It is also possible for two or more grooves to be provided, which receive two or more spring elements. These grooves are preferably embodied on the same component and assure an at least essentially parallel orientation of the inner race body and the outer race body of the roller bearing relative to a desired axis of rotation of the shaft of the motor.

### DRAWINGS

Preferred exemplary embodiments of the invention are described in further detail in the ensuing description in conjunction with the accompanying drawings, in which elements corresponding to one another are identified by the same reference numerals. Shown are:

FIG. 1, an electric motor with a bearing system in a fragmentary sectional view of a first exemplary embodiment of the invention;

FIG. 2, the detail marked II in FIG. 1 in the first exemplary embodiment of the invention, in a more-detailed view;

FIG. 3, the detail marked III in FIG. 2, in a second exemplary embodiment of the invention;

FIG. 4, the detail of the electric motor marked II, in FIG. 1 in a third exemplary embodiment of the invention;

FIG. 5, the detail of the electric motor marked II, in FIG. 1 in a fourth exemplary embodiment of the invention;

FIG. 6, a fragmentary view, partly in section, of a spring element of the bearing system of the electric motor of the invention.

### DESCRIPTION OF THE EXEMPLARY EMBODIMENTS

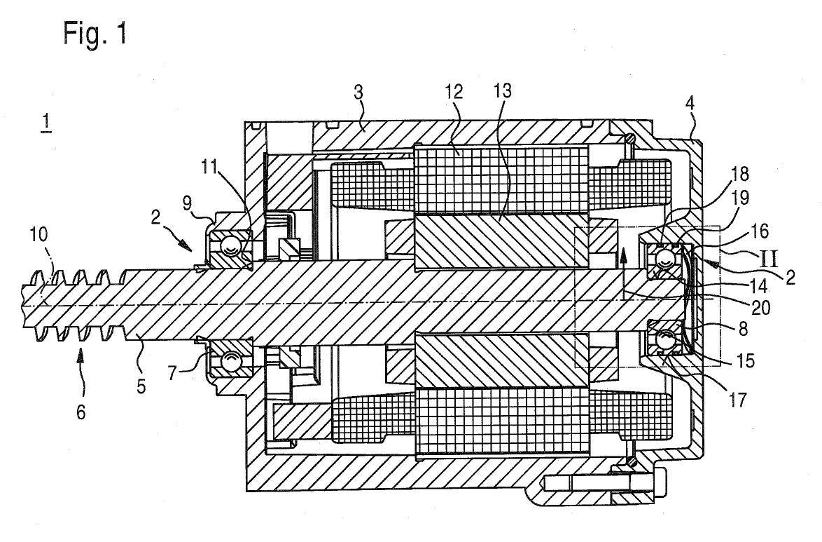

FIG. 1 shows an exemplary embodiment of an electric motor 1 of the invention. The electric motor 1 may in particular be designed as an asynchronous motor and can be used for an electric power steering system. The electric motor 1 can also be used for external-force-actuated adjustment of elements of a motor vehicle. However, the electric motor 1 of the invention is suitable for still other applications as well.

The electric motor 1 is equipped with a bearing system 2, which will be described in detail hereinafter. The electric motor has a housing 3, 4 comprising a plurality of housing parts 3, 4. The electric motor 1 has a shaft 5, which protrudes partway out of the housing 3, 4 and which has an interface 6 that is operatively connected either directly or via a gear to elements of a power steering system or the like. The shaft 5 is supported in the housing 3, 4 of the electric motor 1 via one roller bearing 7 embodied as a fixed bearing and another roller bearing 8 embodied as a loose bearing. The roller bearing 7 is firmly clamped via a crimp 9 of the housing part 3, so that particularly in a radial direction, that is, in the direction of an axis of rotation 10 of the shaft 5, there is no play between the housing part 3 and the roller bearing 7. Moreover, the roller bearing 7 is pressed onto the shaft 5, and the roller bearing 7 rests on a shoulder 11 of the shaft 5, so that there is no play in the axial direction between the roller bearing 7 and the shaft 5, either.

The electric motor 1 furthermore has a stator 12, which is connected to the housing 3, 4 of the electric motor 1 and comprises a plurality of stator packets, and a rotor 13, connected to the shaft 5 and comprising a plurality of rotor packets. In operation of the electric motor 1, by means of the stator 12 and the rotor 13 a torque is generated, which is transmitted to the interface 6 via the shaft 5.

The roller bearing 8 enables an adjustment of the shaft 5 in the direction of the axis of rotation 10. For instance, temperature changes in operation of the electric motor 1 can cause a change in length of the shaft 5 relative to the housing part 3, and this change is thus compensated for. In the exemplary embodiment shown in FIG. 1, the roller bearing 8 is pressed onto the shaft 5 at a face 14 and is braced on a shoulder 15 of the shaft 5. A positioning spring 16 subjects the roller bearing 8 to a positioning force. A sliding seat of the roller bearing 8 is provided at a slide face 17 of the roller bearing 8, and as a result, the roller bearing 8 is displaceable in the direction of the axis of rotation 10. A first spring element 18 and a second spring element 19 are also provided, which are located in the region of the slide face 17 of the roller bearing 8.

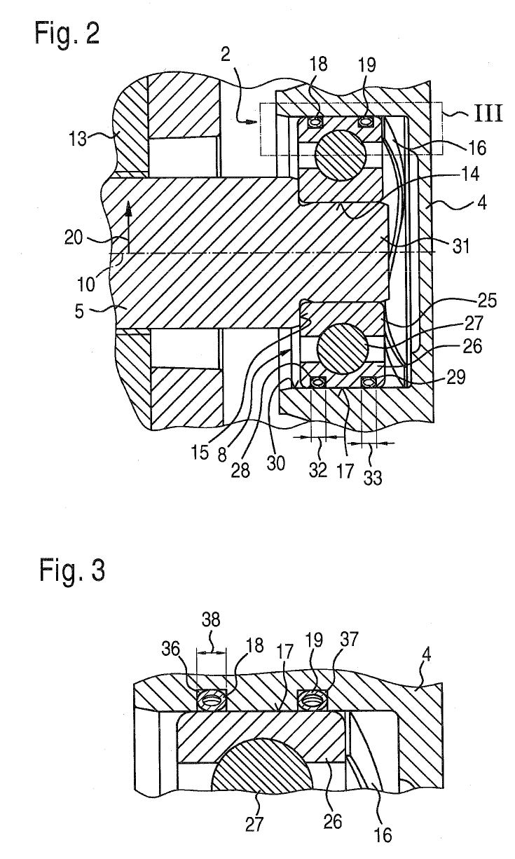

The bearing system 2 includes the roller bearings 7, 8 and the spring elements 18, 19 and assures an at least essentially play-free support of the shaft 5 of the electric motor 1 in a radial direction 20. The design and mode of operation of the bearing system 2 of the electric motor 1 of the first exemplary embodiment of the invention is described below in detail in conjunction with FIG. 2.

FIG. 2 shows the detail marked II in FIG. 1 of the electric motor 1 in greater detail.

The roller bearing 8 of the bearing system 2 has an inner race body 25, an outer race body 26, and roller bodies 27. The roller bodies 27 are located between the inner race body 25 and the outer race body 26 and run in races of the race bodies 25, 26. The roller bearing 8 is designed as a single-row deep-groove ball bearing, and the roller bodies 27 are formed by balls. The roller bearing 8 embodied as a radial bearing can be designed in general as a single- or multiple-row deep-groove ball bearing or roller bearing, in particular a cylinder roller, barrel, needle, or conical roller bearing. The roller bodies 27 may be designed as balls, rollers, barrels, needles, cones, and the usual modifications thereof.

The outer race body 26, in the region of the slide face 17 of the roller bearing 8, has grooves 28, 29 extending all the way around; the first spring element 18 is located in the groove 28, and the second spring element 19 is located in the groove 29. At the face 14 of the shaft 5, the inner race body 25 of the roller bearing 8 is pressed onto the shaft 5. The outer race body 26, in the region of the slide face 17, can also slide in the recess 30 in the housing part 4 in the direction of the axis of rotation 10, to enable a certain mobility of the bearing point for the shaft 5 in the axial direction. The spring elements 18, 19 are prestressed in the radial direction 20, so that play between the outer race body 26 and the housing part 4 is at least essentially prevented. Moreover, the spring elements 18, 19, extending at least approximately parallel to one another in the circumferential direction, assure that the outer race body 26 is mounted at least approximately parallel to the axis of rotation 10 of the shaft 5. Especially on installation of the roller bearing 8 in the housing part 4, a skewed angular position of fewer than 15 arc minutes, and in particular fewer than 10 arc minutes, can be assured. This assures reliable operation of the roller bearing 8 over the life of the electric motor 1. Moreover, the spring elements 18, 19, together with the positioning spring 16, assure that upon a change in the direction of rotation of the electric motor, shaking or knocking is averted or reduced.

Moreover, the shaft 5, roller bearing 8 and housing parts 3, 4 may also comprise different materials. For instance, the shaft 5 and/or the housing part 4 may be of aluminum, while the roller bearing 8 is of steel. In use in a motor vehicle, the operating temperature of the electric motor may fluctuate between −40° C. and +60° C., and relatively major differences in the thermal expansion behavior occur between the components of the electric motor 1 that are formed of aluminum and those formed of steel. The bearing system 2 now enables on the one hand a displaceability of the shaft 5 in the axial direction in the region of one end 31 in order to compensate for such changes in length, and on the other hand, because of the spring elements 18, 19, it enables a reliable orientation of the roller bearing 8 with respect to the axis of rotation 10 of the shaft 5, resulting in an at least essentially play-free support that even upon load changes or changes of the direction of rotation prevent noise, friction, wear, or a shortening of the service life.

A width 32 of the groove 28 is less than a width or diameter of the first spring element 18, if the spring element 18 outside the groove 28 is relaxed, so that upon introduction of the spring element 18 into the groove 28, prestressing of the spring element 18 is brought about. Especially as a result of this, the first spring element 18 protrudes somewhat past the slide face 17 of the outer race body 26 when the roller bearing 8 has not yet been introduced into the recess 30. Upon introduction of the roller bearing 8 into the recess 30 of the housing part 4, prestressing of the spring element 18 in the radial direction 20 then ensues. Accordingly, a width 33 of the groove 29 is less than a width or diameter of the second spring element 19, for the sake of prestressing the spring element 19.

FIG. 3 shows the detail marked III in FIG. 2 of an electric motor 1 with a bearing system, in a second exemplary embodiment of the invention. In this exemplary embodiment, grooves are provided neither on the inner race body 25 nor on the outer race body 26. However, on the housing part 4 of the housing 3, 4 of the electric motor 1, in the region of the recess 30 of the housing part 4 and of the slide face 17 of the outer race body 26 of the roller bearing 8, grooves 36, 37 are provided, which are designed extending all the way around relative to the axis of rotation 10 of the shaft 5. The grooves 36, 37 are thus each embodied cylindrically. The first spring element 18 is inserted at least partway into the groove 36, and the second spring element 19 is inserted at least partway into the groove 37. A width 38 of the groove 36 is less than a width or diameter of the spring element 18, as long as the spring element 18 outside the groove 36 is in the relaxed state. Upon insertion of the spring element 18 into the groove 36, prestressing of the spring element 18 occurs, so that particularly as a result of this, a protrusion of the spring element 18 past the recess 30 of the housing part 4 is brought about. Upon the introduction of the roller bearing 8 into the recess 30, the spring element 18 is pressed at least partway into the groove 36. Thus the spring element 18 in the mounted state of the roller bearing 8 is prestressed in the radial direction 20. The same is correspondingly true for the groove 37 of the housing part 4 and the second spring element 19 provided in the groove 37.

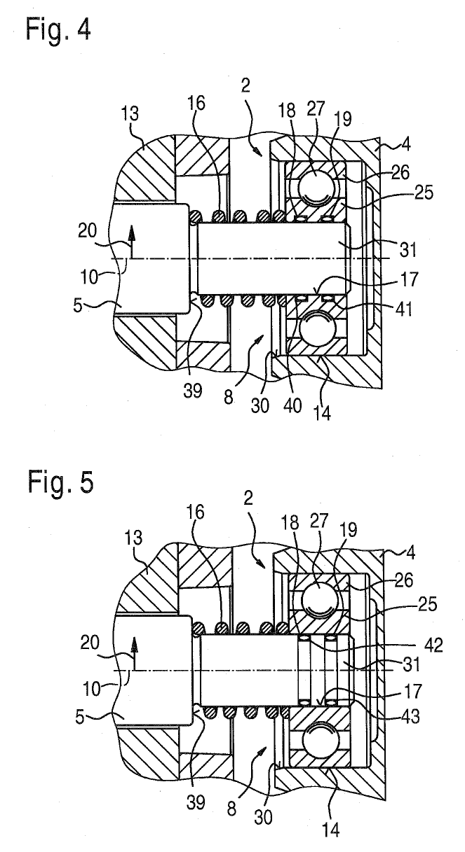

FIG. 4 shows the detail marked II in FIG. 1 of an electric motor 1 with a bearing system 2, in a third exemplary embodiment of the invention. In this exemplary embodiment, the outer race body 26 is pressed, in the region of the face 14, into the recess 30 of the housing part 4, so that the outer race body 26 is not displaceable relative to the housing part 4 of the electric motor 1. A sliding seat relative to the shaft 5 is moreover embodied between the inner race body 25 in the region of a slide face 17. In this case, the positioning spring 16 is located, relative to the roller bearing 8, on the side of the shaft 5, and the positioning spring 16 surrounds the shaft 5 intermittently and is braced on one end on a shoulder 39 of the of the shaft 5 and on the other on the inner race body 25. The inner race body 25 of the roller bearing 8 furthermore has grooves 40, 41, in which the spring elements 18, 19 are located. Because of the prestressing of the spring elements 18, 19, the inner race body 25 is slaved by the shaft 5, and a certain axial displaceability is assured that suffices to compensate for instance for temperature-caused changes in length of the shaft 5 relative to the housing parts 3, 4. Moreover, an at least substantially play-free support of the shaft on its end 31 in the radial direction 20 is made possible.

FIG. 5 shows the detail marked II in FIG. 1 of the electric motor 1 with the bearing system 2, in a fourth exemplary embodiment of the invention. The fourth exemplary embodiment shown in FIG. 5 corresponds essentially to the third exemplary embodiment shown in FIG. 4. However, neither the inner race body 25 nor the outer race body 26 of the roller bearing 8 has a groove. However, on its end 31 in the region of the slide face 17 of the inner race body 25, the shaft 5 has grooves 42, 43, in which the spring elements 18, 19 are located. The grooves 18, 19 embodied on the shaft have widths that are each less than a width or diameter of the corresponding spring element 18, 19, so that prestressing of the spring elements 18, 19 in the radial direction 20 is brought about, as has already been described above in detail in connection with the first and second exemplary embodiments. The same is correspondingly true for the third exemplary embodiment shown in FIG. 4.

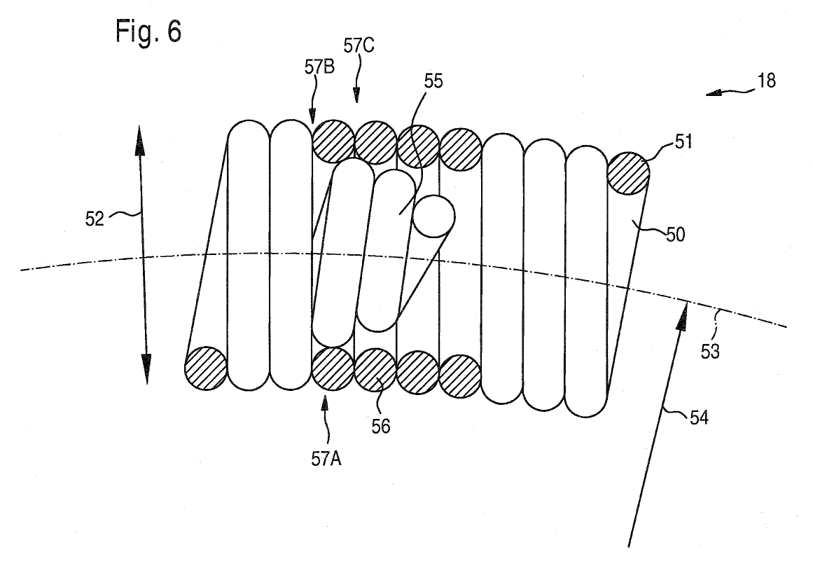

FIG. 6 shows the first spring element 18 in a fragmentary view, partly in section. The spring element 18 has a spirally curved base body 50, which has an at least approximately circular cross section 51. A diameter 52 of the spring element 18 is predetermined by the curvature of the base body 50 relative to a center axis 53. The spring element 18 is moreover curved such that the center axis 53 of the spring element 18 is located at least approximately on a circular line. A mean diameter 54 of the circularly curved center axis 53 of the first spring element 18 is adapted to a mean diameter of the groove 28, the groove 36, the groove 40, or the groove 42. To effect an addition prestressing of the spring element 18, the mean diameter 54 is selected to be preferably somewhat less than the mean diameter of the groove 28, the groove 36, the groove 40, or the groove 42.

To embody the spring element 18 as a closed ring, a first end 55 of the spring element 18 is connected to a second end 56 of the spring element 18. In the embodiment shown in FIG. 6, the first end 55 is inserted into the second end 56, and the winding diameter of the spring element 18 decreases continuously in the vicinity of the first end 55. The first end 55 catches in the windings of the second end 56, and as a result a form-locking connection similar to a screw connection is formed. To further improve the connection of the two ends 55, 56, a connection between the ends 55, 56 can be embodied by soldering or welding in one or more of the regions 57A, 57B, 57C.

In the exemplary embodiment shown of the spring element 18, the diameter 52 also dictates the width of the spring element 18. The second spring element 19 is designed in a way that corresponds to the first spring element 18.

The invention is not limited to the exemplary embodiments described.

1. A bearing system (2) for supporting a shaft (5), in particular for an electric motor (1), having a roller bearing (8) that enables a displaceability of the shaft (5) along an axis of rotation (10) of the shaft (5), and having at least one inner race body (25), at least one outer race body (26), and roller bodies (27) located between the inner race body (25) and the outer race body (26), and having at least one spring element (18), which is located in a region of a slide face (17) of the roller bearing (8), which slide face enables the displaceability of the shaft (5) along the axis of rotation (10) and is provided on one of the race bodies, and the spring element is prestressable in a radial direction (20) in order to enable an at least substantially play-free support of the shaft (5) in the radial direction (20).

2. The bearing system as defined by claim 1,
characterized in that
the spring element (18) is embodied as a wormlike tension spring.

3. The bearing system as defined by claim 1,
characterized in that
the spring element (18) is designed as a closed ring, and a first end (55) of the spring element (18) is connected to a second end (56) of the spring element (18).

4. The bearing system as defined by claim 3,
characterized in that
the first end (55) of the spring element (18) is inserted into the second end (56) of the spring element (18) for form-locking connection of the first end (55) of the spring element (18) to the second end (56) of the spring element (18).

5. The bearing system as defined by claim 3,
characterized in that
the first end (55) of the spring element (18) to the second end (56) of the spring element (18) is connected by a soldered or welded connection for connecting the first end (55) of the spring element (18).

6. The bearing system as defined by claim 1,
characterized in that
the outer race body (26) of the roller bearing (7) has at least one outer groove (28), in which the spring element (18) is at least partly located.

7. The bearing system as defined by claim 6,
characterized in that
a width (32) of the outer groove (28) of the outer race body (26) is less than a width of the relaxed spring element (18); and that the spring element (18) is prestressed because of its location in the outer groove (28).

8. The bearing system as defined by claim 1,
characterized in that
the inner race body (25) of the roller bearing (8) has at least one inner groove (40), in which the spring element (18) is at least partly located.

9. The bearing system as defined by claim 6,
characterized in that
a width of the inner groove (40) of the inner race body (25) is less than a width of the relaxed spring element (18); and that the spring element (18) is prestressed because of its location in the inner groove (40).

10. An electric motor, in particular a motor for an electric power steering system, having a rotor (13) and a stator (12) that serve to drive a shaft (5), wherein the shaft (5) is supported by means of a bearing system (2) as defined by claim 1.

11. The electric motor as defined by claim 10,
characterized in that
the shaft (5) has at least one groove (42); and that the spring element (18) is located at least partly in the groove (42).

12. The electric motor as defined by claim 10,
characterized in that
a housing part (4) is provided with a recess (30) for receiving the roller bearing (8); that the housing part (4), in the region of the recess (30), has at least one groove (36); and that the spring element (18) is located at least partly in the groove (36).
